(19) United States
(12) Patent Application Publication
(10) Pub. No.: US 2011/0063818 A1
(43) Pub. Date: Mar. 17, 2011

(54) Desk lamp

(76) Inventors: Tai-Hsiang Huang, Yongkang City (TW); Kuan-Hsiang Huang, Yongkang City (TW)

(21) Appl. No.: 12/585,480

(22) Filed: Sep. 16, 2009

(51) Int. Cl. H02J 7/00

(52) U.S. Cl. 362/20

(57) ABSTRACT

A desk lamp in which the power input terminal of the desk lamp is connected to a charge circuit and an input terminal of a relay. The charge circuit enables the charging for a charge battery accommodated in a battery chamber of the base, while the other input terminal of the relay is also connected to the charge battery. In electric power cut state, power supply is automatically switched to the mode with the electricity coming from the charge battery, and an auxiliary lamp continue to emit light to serve as a night light when the switch is turned off. The desk lamp can be used as an emergency light during electric power cut state. The position of the lamp itself can be clearly indicated for users to find easily.

### BACKGROUND OF THE INVENTION

1. Field of the Invention

The present invention relates to a desk lamp, especially to a desk lamp having different power supply mode such that power supply is automatically switched to the mode with electricity coming from a charge battery in electric power cut state, and an auxiliary lamp continue to emit light to serve as a night light when the switch is turned off, or the desk lamp can be used as an emergency light in electric power cut state in dark condition, and the position of the lamp itself can be clearly indicated for users to find easily and to use it as an emergency light. It can increase more practical value in the integral embodiment and usage thereof.

2. Brief Description of Prior Art

The creation and usage of lamp illumination equipment has improved the inconvenience resulted from dim light at night. In order to enhance the low light intensity caused by low illumination lamp, far-site installation of lamp or obstruction of light emitted from the lamp, the industries have developed various types of desk lamp for near-site installation by which ordinary users can put it nearby and turn it on for better illumination purpose such that user can avoid fatigue or uncomfortableness of eye, vision decline etc. due to insufficiency in luminance of lighting during reading, writing or operating of personal computer.

Although the above desk lamp can reach expected effectiveness of illumination and near-site installation, however it is found in practical implementation that pitch dark state is caused by the die-out of lighting in case the switch is in turn-off state. Further, in the case of electric power cut condition, the light emitted from the desk lamp extinguishes and fails to provide required light for illumination anymore. Thus, in the turn-off state of switch or in emergency condition such as electric power cut, desk lamp loses illumination function and the whole circumstance becomes pitch dark, such that users is apt to be endangered. This will bring about great inconvenience in its whole implementation and usage.

In view of the above facts, the inventor of the present invention provides a new desk lamp according to the improvement conducted on defects of the conventional structure based on his abundant experience of R&D and manufacturing in relevant field so as to attain the goal of obtaining better practical value.

### SUMMARY OF THE INVENTION

The desk lamp of the present invention comprises a power switch on the base which is connected with a lamp for illumination. An auxiliary lamp is further provided on the base, and a power cord is connected to the bottom. The base is also provided with a battery chamber which is used for accommodating charge battery. The power input terminal of the desk lamp is connected to a charge circuit and an input terminal of a relay. The charge circuit can conduct charging for a charge battery accommodated in the battery chamber of the base, while the other input terminal of the relay is also connected to the charge battery. The output terminal of the relay is connected to the power switch on the base, and the ON state output terminal of the power switch is connected to the illumination lamp, the OFF state output terminal of the power switch is connected to the auxiliary lamp. In this manner, the desk lamp of the present invention not only has different power supply mode such that power supply is automatically switched to the mode with electricity supplying from the charge battery in electric power cut state, and an auxiliary lamp continue to emit light to serve as a night light when the switch is turned off, or the desk lamp can be used as an emergency light in electric power cut state in dark condition, and the position of the lamp itself can be clearly indicated for users to find easily and to use it as an emergency light. It can increase more practical value in the integral embodiment and usage thereof.

### BRIEF DESCRIPTION OF THE DRAWINGS

FIG. 1 is a perspective outline view showing the structure of the desk lamp of the present invention.

FIG. 2 is a side view showing the structure of the desk lamp of the present invention.

FIG. 3 is a front view showing the structure of the desk lamp of the present invention.

FIG. 4 is a schematic view showing the circuit of the desk lamp of the present invention.

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

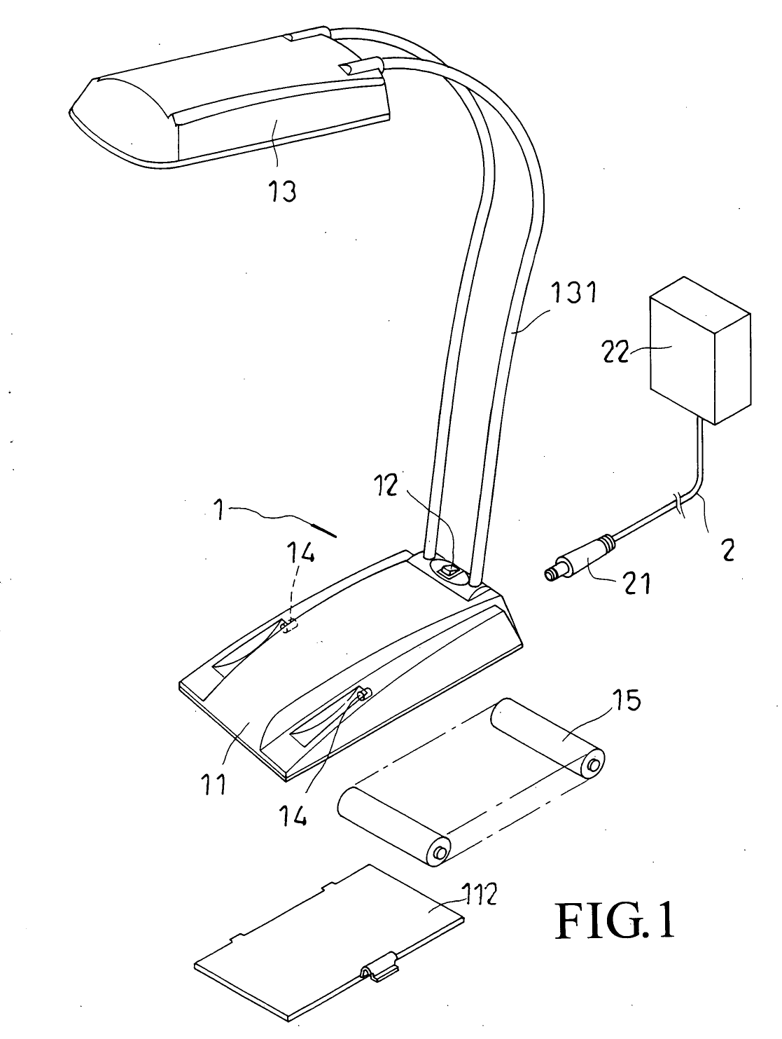

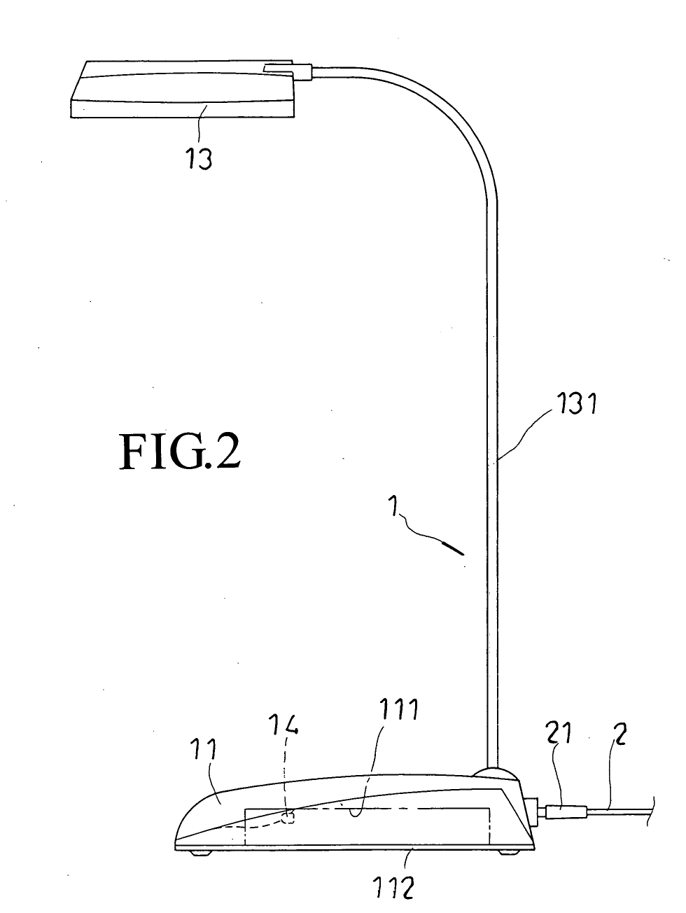

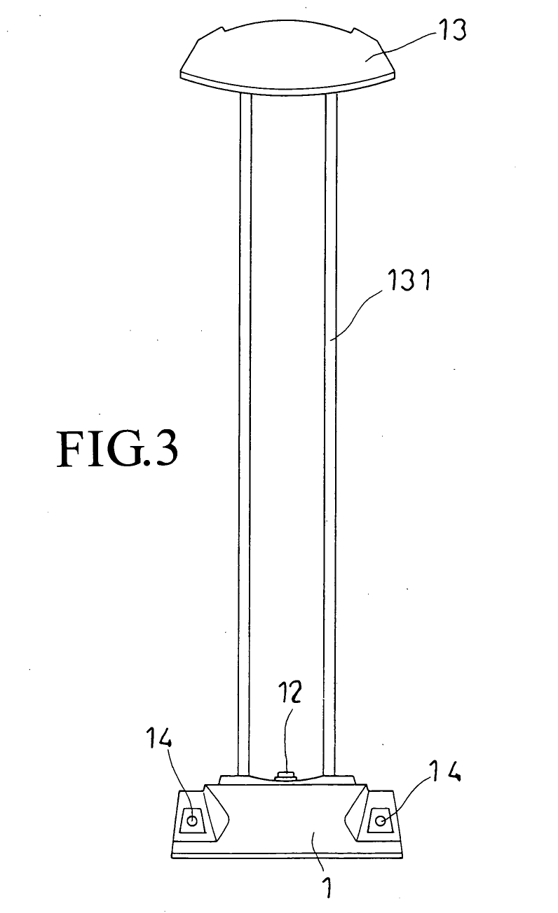

FIG. 1 is a perspective outline view showing the structure of the desk lamp of the present invention. FIG. 2 is a side view showing the structure of the desk lamp of the present invention. FIG. 3 is a front view showing the structure of the desk lamp of the present invention. As shown in these figures, in the desk lamp (1) of the present invention, a power switch (12) is provided on the base (11) which is connected with an illumination lamp (13) through a connecting rod (131). Further, an auxiliary illumination lamp (14) is provided on the base (11).

A coupler (21) provided on one end of the power lead (2) is connected to the base (11), and a transformer plug (22) is provided at the other end of the power lead (2). Further, a battery chamber (111) for accommodating charge battery (15) is also provided in the base (11) and is covered by a lid (112).

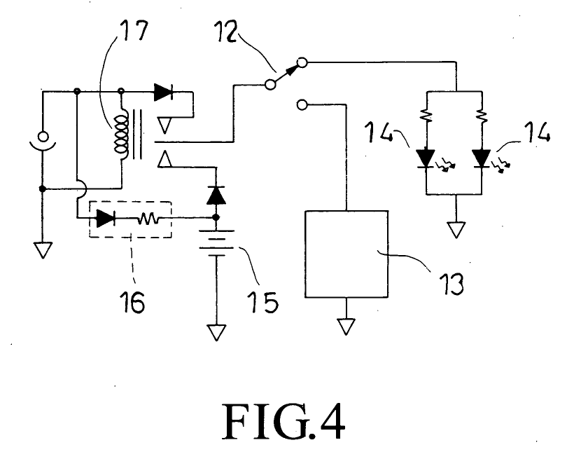

FIG. 4 is a schematic view showing a circuit of the desk lamp of the present invention. The power input terminal of the desk lamp (1) is connected to a charge circuit (16) and an input terminal of a relay (17). The charge circuit (16) can conduct charging for the charge battery (15) accommodated in the battery chamber (111) of the base (11), while the other input terminal of the relay (17) is also connected to the charge battery (15). The output terminal of the relay (17) is connected to the power switch (12) on the base (11), and the ON state output terminal of the power switch (12) is connected to the illumination lamp (13), the OFF state output terminal of the power switch (12) is connected to the auxiliary lamp (14).

In this manner, after the base (11) of the desk lamp (1) is connected with the coupler (21) of the power lead (2) and the transformer plug (22) on other end of the power lead (2) is connected to the utility power, the charge battery (15) received in the battery chamber (111) of the base (11) utility power will be charged by utility power through the charge circuit (16). Utility power also flows to the power switch (12) on the base (11) through the relay (17) so that the power switch (12) is supplied with utility power. At this moment, if the power switch (12) is in OFF state, then the auxiliary illumination lamp (14) can get the power supply so as to be lightened. If the power switch (12) is in ON state, then the illumination lamp (13) get the power supply so as to be lightened, simultaneously the auxiliary illumination lamp (14) is in opened state so as to be extinguished.

When electricity is in electricity power cut state, the relay (17) conducts switching so that the power switch (12) gets power supply from the charge battery (15) accommodated in the battery chamber (111) of the base (11). In this manner, power required for the lightening of the illumination lamp (13) and the auxiliary illumination lamp (14) can also be provided.

The abovementioned embodiment and drawings are not used to restrict the structural aspect of the present invention. Variations and modifications made by the person having ordinary knowledge in the art without departing from the spirit and scope of the present invention are still regarded to be within the scope of the present invention.

Based on the foregoing, in the desk lamp of the present invention, the power input terminal of the desk lamp is connected to a charge circuit and an input terminal of a relay. The charge circuit can conduct charging for a charge battery accommodated in the battery chamber of the base, while the other input terminal of the relay is also connected to the charge battery. The output terminal of the relay is connected to the power switch on the base, and the ON state output terminal of the power switch is connected to the illumination lamp, the OFF state output terminal of the power switch is connected to the auxiliary lamp. In this manner, the desk lamp of the present invention not only has different power supply mode such that power supply is automatically switched to the mode with a electricity supply from a charge battery in electric power cut state, and an auxiliary lamp continue to emit light to serve as a night light when the switch is turned off, or the desk lamp can be used as an emergency light during electric power cut state in dark condition, and the position of the lamp itself can be clearly indicated for users to find easily and to use it as an emergency light. It can increase more practical value in the integral embodiment and usage thereof.

What is claimed is:

1. A desk lamp, wherein a power switch is provided on the base which is connected with a lamp for illumination, an auxiliary lamp being further provided on the base, and a power cord being connected on the bottom, the base being also provided with a battery chamber which is used for accommodating charge battery, the power input terminal of the desk lamp being connected to a charge circuit and an input terminal of a relay, the charge circuit enabling the charging for a charge battery accommodated in the battery chamber of the base, while the other input terminal of the relay being also connected to the charge battery, the output terminal of the relay being connected to the power switch on the base, and the ON state output terminal of the power switch being connected to the illumination lamp, the OFF state output terminal of the power switch being connected to the auxiliary lamp.
